(19) United States
(12) Patent Application Publication
(10) Pub. No.: US 2026/0342031 A1
(43) Pub. Date: Oct. 29, 2026

(54) OPTICAL WINDOW PROTECTION IN DIODE PUMPED ALKALI LASERS

(71) Applicant: RAFAEL ADVANCED DEFENSE SYSTEMS LTD., Haifa (IL)

(72) Inventors: Michael EPSHTEIN, Haifa (IL); Mara BARABAN, Haifa (IL); Shai ZAMIR, Haifa (IL); Ilan HAKIMI, Haifa (IL)

(21) Appl. No.: 19/482,877

(22) PCT Filed: May 9, 2024
(86) PCT No.: PCT/IB2024/054522

§ 371 Date: Nov. 10, 2025

(30) Foreign Application Priority Data
May 10, 2023 (IL) 302909

(51) Int. Cl. H01S 3/034; H01S 3/03; H01S 3/227

(52) U.S. Cl. CPC H01S 3/0346; H01S 3/031; H01S 3/227

(57) ABSTRACT

The invention provides methods and apparatus for protecting a DPAL optical window from damage caused by exposure to alkali atoms in the DPAL gain medium, in which an ion-deflecting, applied electric field is formed inside an enhanced ionization region which is proximal to the DPAL optical window. Ionization inside this region is enhanced by photoionization and/or electrostatic discharge. Photoionization is either a single-photon process involving photons from an ionizing laser beam or a multi-photon process involving photons from an optical pumping beam and/or an ionizing laser beam. The invention may be used in combination with other window protection techniques proposed in the prior art.

### FIELD OF THE INVENTION

The present invention relates to the optical windows of Diode Pumped Alkali Lasers (DPALs) and specifically to methods and apparatus for protecting the optical windows of DPALs from damage caused by exposure to atomic alkali.

### BACKGROUND OF THE INVENTION

The effectiveness of high power DPALs is reduced by damage caused to optical windows exposed to alkali atoms present in the DPAL gain cell. Damage typically causes absorption and scattering of pumped laser light passing through the window, causing the window to have reduced optical transmission and possibly to suffer catastrophic failure due to overheating. Furthermore, diffusion of atomic alkali into the window material reduces the number density of alkali atoms remaining in the gain cell, thus diminishing laser efficiency.

U.S. Pat. No. 9,653,869, issued May 16, 2017 to F. W. Hersman et al., entitled “Optical Surface Preservation Techniques and Apparatus”, which is referred to hereinafter as '869, discloses techniques and architecture for preserving optical surfaces (e.g. windows, coatings, etc.) in a flowing gas amplifier laser system, such as a DPAL system. The system includes a DPAL having an optical pumping cavity, and a flow assembly optically coupled with the optical pumping cavity. The flow assembly includes a first and a second conduit configured to deliver a flow of a lasing gas and of a first non-alkali gas, respectively, to the optical pumping cavity.

U.S. Pat. No. 10,275,999, issued Apr. 30, 2019, to M. D. Rotondaro et al., entitled “Flowing Gas, Laser Pumped, Alkali Metal Laser with Thermal Confinement of Alkali Metal”, which is referred to hereinafter as '999, teaches an optically pumped, flowing gas, alkali metal laser which includes a gas passageway transporting an alkali metal vapor and a hydrocarbon buffer gas, and a laser propagation passageway which intersects the gas passageway and forms a main cell at the intersection. A pump laser is directed into the main cell and produces a main laser beam in the laser propagation passageway. The flowing hydrocarbon buffer gas is disposed in the main cell with a density to induce spin-orbit relaxation in the alkali metal vapor. At least one window is disposed in the laser propagation passageway, and the window is protected from deposits of alkali metal or carbon by a heated leading edge in the laser propagation passageway that re-vaporizes alkali metal and returns it to the gas passageway via a convective gas flow.

### SUMMARY OF THE INVENTION

The invention provides methods and apparatus for protecting an optical window of a Diode Pumped Alkali Laser (DPAL) from damage caused by exposure to alkali atoms inside a DPAL gain cell.

According to the teachings of an embodiment of the present invention, there is provided a method for protecting an optical window of a Diode Pumped Alkali Laser (DPAL) from damage caused by exposure to alkali atoms inside a DPAL gain cell. The method includes forming an ion-deflecting applied electric field in an enhanced ionization region, which is located inside the DPAL gain cell and proximal to the optical window.

According to a feature of the invention, the alkali atoms are converted to cations inside the enhanced ionization region by a process of photoionization and/or by a process of electrostatic discharge.

According to a further feature, the ion-deflecting applied electric field accelerates alkali cations in a direction substantially parallel to the optical window.

According to a further feature, the ion-deflecting applied electric field accelerates alkali cations in a direction substantially perpendicular to and away from the optical window.

According to a further feature, the ion-deflecting applied electric field is formed by an electrode assembly comprising solid and/or mesh electrodes.

According to a further feature, the ion-deflecting applied electric field is formed by an electrode assembly including an electrode which is at a ground potential.

According to a further feature, the process of photoionization involves photons provided by an ionizing laser beam.

According to a further feature, photons of the ionizing laser beam are trapped inside an optical resonant cavity.

According to a further feature, a wavelength of the ionizing laser beam is less than or equal to a threshold wavelength determined by the lowest ionization energy of the alkali atoms, and the photoionization is a single-photon process.

According to a further feature, a wavelength of the ionizing laser beam is greater than a threshold wavelength determined by the lowest ionization energy of the alkali atoms, and the photoionization is a multi-photon process.

According to a further feature, the multi-photon process involves photons provided by the ionizing laser beam and/or an optical pumping beam.

According to a further feature, the ionizing laser beam is formed by harmonic and/or sum frequency generation.

According to a further feature, an average power of the ionizing laser beam is at least an order of magnitude smaller than that of an optical pumping beam.

According to a further feature, the DPAL is a static or a flowing DPAL.

According to the teachings of another embodiment of the present invention, there is provided an apparatus for protecting an optical window of a Diode Pumped Alkali Laser (DPAL) from damage caused by exposure to alkali atoms inside a DPAL gain cell. The apparatus includes an electrode assembly configured to form an ion-deflecting applied electric field in an enhanced ionization region, which is located inside the DPAL gain cell and proximal to the optical window.

According to a feature of the invention, the alkali atoms are converted to cations inside the enhanced ionization region by a process of photoionization and/or by a process of electrostatic discharge.

According to a further feature, the process of photoionization involves photons provided by an ionizing laser beam.

According to a further feature, the ion-deflecting applied electric field accelerates alkali cations in a direction substantially parallel to the optical window.

According to a further feature, the ion-deflecting applied electric field accelerates alkali cations in a direction substantially perpendicular to and away from the optical window.

According to a further feature, the ion-deflecting applied electric field is formed by an electrode assembly including solid or mesh electrodes.

According to a further feature, the ion-deflecting applied electric field is formed by an electrode assembly including an electrode which is at a ground potential.

According to a further feature, the DPAL is a static or a flowing DPAL.

### BRIEF DESCRIPTION OF THE DRAWINGS

The invention is herein described, by way of example only, with reference to the accompanying drawings.

FIG. 1 is a schematic drawing of an exemplary DPAL according to an embodiment the invention.

FIGS. 2A and 2B are cross-sectional drawings of an apparatus which includes an electrode assembly configured to create an ion-deflecting, applied electric field to prevent alkali ions from reaching the optical pumping window.

FIG. 3 is an exemplary graph showing the single-photon photoionization cross-section (6) for atomic Rubidium as a function of photon wavelength, in the ultraviolet range.

### DETAILED DESCRIPTION OF THE PREFERRED EMBODIMENTS

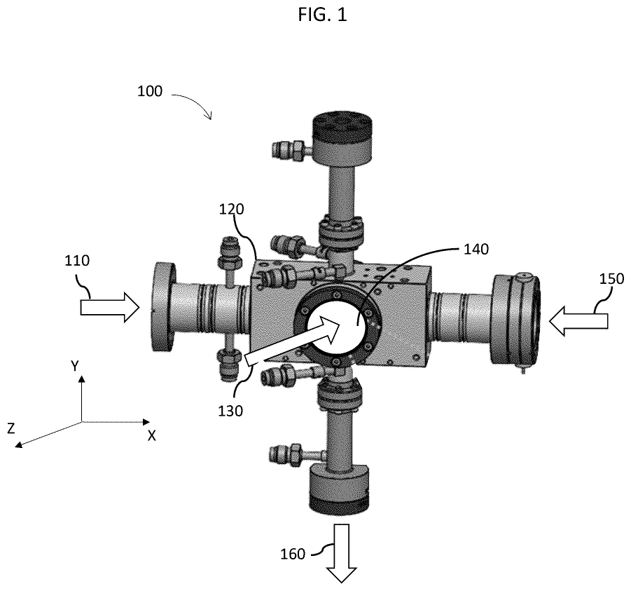

FIG. 1 shows a schematic drawing of an exemplary DPAL, according to an embodiment of the invention. Although the figure shows a flowing DPAL, the invention is applicable to static DPALs as well.

Gas flow 110, which passes into the DPAL gain cell 120, typically includes an alkali vapor, a buffer gas, and a spin-orbit relaxing (SOR) gas. Alkali gain media that are commonly used in DPALs include Rubidium (Rb), Cesium (Cs), and Potassium (K) vapor. The buffer gas, e.g. Helium, Neon, Argon, Krypton, or Xenon, increases optical pumping efficiency by pressure broadening the alkali absorption line. The SOR gas, or fine-structure mixing gas, is used to quickly bring excited alkali atoms down from the ²P_{3/2} state to the ²P_{1/2} lasing state. Examples of such gases are Hydrogen, Nitrogen, Oxygen, Methane, Ethene, or Ethane.

As shown in FIG. 1, an optical pumping beam 130 is incident on an optical pumping window 140 in the direction of the −Z-axis, perpendicular to the X-Y plane of the drawing. The central wavelength of the pumping beam depends upon the alkali element used as a gain medium. For example, 794.11, 894.59, and 770.11 nanometers (nm.) are typical of the pumping central wavelengths used for the Rb, Cs, and K gain media, respectively.

An ionizing laser beam 150 enters the gain cell 120 in the direction of the negative X-axis. The wavelength and angular divergence of ionizing laser beam 150 is chosen to enhance ionization of neutral alkali atoms in a region located in the vicinity of, or in close proximity to, the surface of window 140 on the side exposed to the alkali gain medium; hereinafter referred to as the “inner surface” of window 140.

The DPAL emitted laser beam 160 is shown in FIG. 1 as propagating in the minus Y direction. Beam 160 is generated by the spontaneous emission of photons by alkali atoms transitioning from the ²P_{1/2} excited state to the ²S_{1/2} ground state. Typical wavelengths for the DPAL emitted laser beam are 795, 895, and 770 nm., for the Rb, Cs, and K gain media, respectively.

### Ion-Deflecting Applied Electric Field

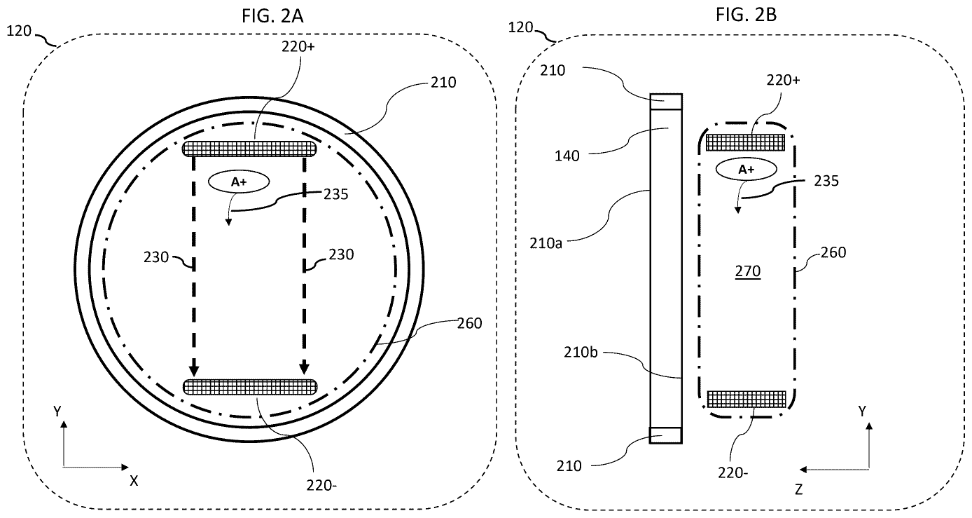

FIGS. 2A and 2B show cross-sectional drawings of an apparatus which includes an electrode assembly configured to create an ion-deflecting, applied electric field 230 to prevent alkali ions from striking the inner surface of the optical pumping window 140. FIG. 2A shows an X-Y cross-section, as seen when looking into the gain cell 120 through the window 140. FIG. 2B shows a side view of the window and the interior of the gain cell, in the Y-Z plane.

Window flange 210 seals the pumping window 140 on its outer surface 210a and its inner surface 210b. An electrode assembly consisting of a positive electrode 220+ and a negative electrode 220− forms an ion-deflecting, applied electric field 230 which accelerates alkali cations A+ in the −Y direction, substantially parallel to the window 140, thereby preventing the cations from striking and causing damage to the window. The electrodes may be solid or mesh electrodes. The magnitude of the applied electric field 230 depends upon the distance and the electric potential difference between the electrodes 220+ and 220− as well as the field generated by space charge, e.g. free ions and electrons, inside the gain cell. In some embodiments, the electrode 220+ is maintained at the DPAL ground potential.

The trajectory 235 of the alkali cations as they pass through the applied electric field 230 depends, among other factors, upon the magnitude of the electric field, the ion mobility, the gas pressure, and the thermal energy of the alkali atoms inside the gain cell 120. The shape and magnitude of the applied electric field must take into account the thermal velocity distribution of the alkali ions, which generally includes a velocity component pointing towards the window 140. The latter gives rise to the initial curvature of the trajectories 235 towards the window, as shown in FIGS. 2A and 2B.

The dot-dash curve 260 encloses an enhanced ionization region 270 in which neutral alkali atoms from the gain medium are converted to alkali cations, A+, by one or more enhanced ionization processes that are detailed in the following subsection. After deflection, the cations pass out of region 270 and travel by convective flow to other parts of the gain cell where they scatter and return to being neutral alkali atoms The latter continue to absorb optical pumping energy and to contribute to the power of the emitted laser beam 160.

In some embodiments of the invention, the placement of the electrodes 220+ and 220− differs from that shown in FIGS. 2A and 2B, such that the electrodes are substantially parallel to the optical window 140, with the positive electrode 220+ positioned closer to the window. In this case, the electrodes produce an ion-deflecting applied field which accelerates alkali cations in a direction substantially perpendicular to and away from the optical window.

In addition to protecting the window 140, the presence of electrodes 220+ and 220− inside the DPAL gain cell has the additional advantage of improving lasing efficiency by reducing the number of collisions between neutral alkali atoms and also between neutral alkali atoms and the atoms of the buffer and/or SOR gases. Such collisions tend to reduce efficiency in several ways. First, the collisions raise the alkali atoms to excited levels that may render them non-absorbing, or “invisible”, to the photons of the optical pumping beam 130. Second, the collisions cause excited alkali atoms to return to the ground state, thus reducing the population inversion needed for spontaneous emission. Third, when the buffer/SOR gases contains carbon, such as Methane, Ethene, or Ethane, the collisions may further damage the pumping window 140 by coating it with carbonization.

### Enhanced Ionization Region

In one embodiment of the invention, the density of alkali ions in region 270 is enhanced by a photoionization process, in which photons from the ionizing laser beam 150 and/or from the optical pumping beam 130 eject electrons from the neutral alkali atoms passing through region 270.

In some embodiments of the invention, the photoionization process is an enhanced single-photon process. In this case, ionizing laser beam 150, which may be a pulsed or continuous-wave (cw) beam, is configured to have a wavelength that is less than or equal to a threshold value for single-photon ionization, which is λ_{I}=(h c/E_{I}), where “h” is Planck's constant, “c” is the speed of light, and “E_{I}” is the lowest ionization energy of the alkali gain medium. Table 1 shows exemplary values for λ_{I} and E_{I} for various alkali elements that are commonly used as DPAL gain media.

TABLE 1
Single photon ionization parameters

| Alkali | E_{I} (in eV) | λ_{I} (in nm.) |
|---|---|---|
| Rubidium (Rb) | 4.18 | 296.6 |
| Cesium (Cs) | 3.89 | 318.7 |
| Potassium (K) | 4.34 | 285.7 |

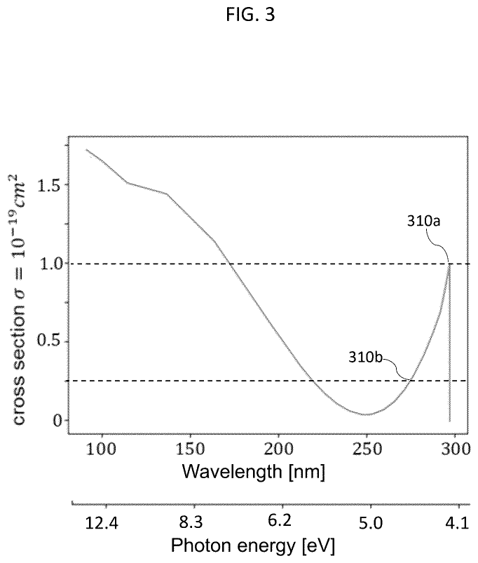

FIG. 3 shows an exemplary graph of the single-photon photoionization cross-section (6) for atomic Rubidium as a function of the photon wavelength, in the ultraviolet optical range. The point 310b corresponds to a wavelength of 266 nm. which may be generated, for example, using an ultraviolet laser, or by third-harmonic generation using a 1064 nm. laser.

The point 310a, which has a higher value of σ and thus a higher photoionization efficiency, corresponds to the values E_{I}=4.18 eV and λ_{I}=296.6 nm., which appear also in Table 1. In this case, the ionizing laser beam 150 may be generated, for example, by a single frequency doubler and sum frequency generation using a 1050 nm. laser and a 1550 nm. laser.

Although the value of σ at point 310b is only about one quarter of that for point 310a, the slope of the curve in FIG. 3 is smaller at point 310b than at point 310a. Thus, the cross-section at point 310b is more stable with respect to wavelength fluctuations of the ionizing laser beam than at point 310a.

In some embodiments of the invention, an optical resonating cavity 260, or “optical resonator” surrounds the enhanced ionization region 270. The cavity 260 is configured to trap the photons provided by ionizing laser beam 150 inside the region 270, in order to increase the likelihood of photon-alkali interactions. The design of optical resonators is well-known to those skilled in the field of electro-optics.

Photoionization inside region 270 may also occur by a multi-photon ionization process, in which photons of the optical pumping beam 130 also participate. In this case, the photons of the ionizing laser beam 150 need only provide a portion of the ionization energy E_{I}, and therefore the wavelength of the ionizing laser beam 50 may be chosen to be greater than λ_{I}.

The photoionization rate inside region 270 depends inter alia upon the pressure of the alkali vapor, the power of the ionizing laser beam 150 and, in the case of multi-photon ionization, the power of the optical pumping beam 130. In high power applications, the optical pumping beam 130 typically has an average power of 100 kilowatts (kW) or more, whereas the average power of the ionizing laser beam 150 is at least one order of magnitude smaller. In some embodiments, the ionizing laser beam 150 is smaller by three orders of magnitude or more.

Furthermore, there are alternative embodiments of the invention which do not require an ionizing laser beam 150 at all. In one such embodiment, the optical pumping beam 130 by itself is powerful enough to provide sufficient photoionization in region 160 through a multi-photon ionization process. In another such embodiment, the ionization in region 160 is enhanced electrostatically by pulsing a high voltage potential difference between the electrodes 220+ and 220−, or between a different set of electrodes.

The window protection methods and apparatus of the invention may be used alone or in combination with other window protection techniques, such as those disclosed in the aforementioned patents '869 and '999, and those that rely, for example, on thermal confinement, gas pressure differences, and boundary layer flows in the vicinity of the pumping window.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for protecting an optical window of a Diode Pumped Alkali Laser (DPAL) from damage caused by exposure to alkali atoms inside a DPAL gain cell, the method comprising forming an ion-deflecting applied electric field in an enhanced ionization region, which is located inside the DPAL gain cell and proximal to the optical window.

2. The method of claim 1 wherein the alkali atoms are converted to cations inside the enhanced ionization region by a process of photoionization and/or by a process of electrostatic discharge.

3. The method of claim 1 wherein the ion-deflecting applied electric field accelerates alkali cations in a direction substantially parallel to the optical window.

4. The method of claim 1 wherein the ion-deflecting applied electric field accelerates alkali cations in a direction substantially perpendicular to and away from the optical window.

5. The method of claim 1 wherein the ion-deflecting applied electric field is formed by an electrode assembly comprising solid and/or mesh electrodes.

6. The method of claim 1 wherein the ion-deflecting applied electric field is formed by an electrode assembly comprising an electrode which is at a ground potential.

7. The method of claim 2 wherein the process of photoionization involves photons provided by an ionizing laser beam.

8. The method of claim 7 wherein photons of the ionizing laser beam are trapped inside an optical resonant cavity.

9. The method of claim 7 wherein a wavelength of the ionizing laser beam is less than or equal to a threshold wavelength determined by the lowest ionization energy of the alkali atoms, and the photoionization is a single-photon process.

10. The method of claim 7 wherein a wavelength of the ionizing laser beam is greater than a threshold wavelength determined by the lowest ionization energy of the alkali atoms, and the photoionization is a multi-photon process.

11. The method of claim 10 wherein the multi-photon process involves photons provided by the ionizing laser beam and/or an optical pumping beam.

12. The method of claim 7 wherein the ionizing laser beam is formed by harmonic and/or sum frequency generation.

13. The method of claim 7 wherein an average power of the ionizing laser beam is at least an order of magnitude smaller than that of an optical pumping beam.

14. The method of claim 1 wherein the DPAL is a static or a flowing DPAL.

15. An apparatus for protecting an optical window of a Diode Pumped Alkali Laser (DPAL) from damage caused by exposure to alkali atoms inside a DPAL gain cell, the apparatus comprising an electrode assembly configured to form an ion-deflecting applied electric field in an enhanced ionization region, which is located inside the DPAL gain cell and proximal to the optical window.

16. The apparatus of claim 15 wherein the alkali atoms are converted to cations inside the enhanced ionization region by a process of photoionization and/or by a process of electrostatic discharge.

17. The apparatus of claim 16 wherein the process of photoionization involves photons provided by an ionizing laser beam.

18. The apparatus of claim 15 wherein the ion-deflecting applied electric field accelerates alkali cations in a direction substantially parallel to the optical window.

19. The apparatus of claim 15 wherein the ion-deflecting applied electric field accelerates alkali cations in a direction substantially perpendicular to and away from the optical window.

20. The apparatus of claim 15 wherein the ion-deflecting applied electric field is formed by an electrode assembly comprising solid or mesh electrodes.

21. The apparatus of claim 15 wherein the ion-deflecting applied electric field is formed by an electrode assembly comprising an electrode which is at a ground potential.

22. The apparatus of claim 15 wherein the DPAL is a static or a flowing DPAL.
